(19) United States
(12) Patent Application Publication
(10) Pub. No.: US 2026/0246686 A1
(43) Pub. Date: Aug. 20, 2026

(54) COMMUNICATION ISSUE CAUSATION IDENTIFICATION

(71) Applicant: HEWLETT PACKARD ENTERPRISE DEVELOPMENT LP, Spring, TX (US)

(72) Inventors: Venkata Varadhan Devarajan, Bangalore (IN); Vijeesh Erankotte Panayamthatta, Bangalore (IN)

(21) Appl. No.: 19/190,678

(22) Filed: Apr. 27, 2025

(30) Foreign Application Priority Data
Feb. 18, 2025 (IN) 202541014080

(51) Int. Cl. H04L 41/0631; H04L 43/0864; H04L 43/0882; H04L 47/11

(52) U.S. Cl. CPC H04L 41/0631; H04L 43/0864; H04L 43/0882; H04L 47/11

(57) ABSTRACT

Techniques are provided for identifying the location of network communication issues between a client device and an endpoint. Specifically, indicators of performance issues (IPI) data, associated with a network communication between a client device and an endpoint, and queue monitoring data, associated with a plurality of intermediate routing devices on the path between the client device and the endpoint, may be used to determine a particular component of the network communication as a cause of a communication issue between the client device and the endpoint. An alert may be generated indicating the particular component that is determined to be a cause of the communication issue.

### BACKGROUND

As computer networks become more sophisticated, network communications may involve an increasing number of different components. Indeed, in network communications between a client device and a destination endpoint, many intermediate components may facilitate a portion of the network communications. For example, a number of different data forwarding devices, such as routers, switches, etc. may forward data from the client device to the destination endpoint and vice versa. Further, some of these intermediate components may exist on a local network (e.g., a local area network (LAN)) while other intermediate components may exist in a remote or non-local network (e.g., a wide area network (WAN)).

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a block diagram, illustrating a network-based communications system with a network issue causation detection system, in accordance with aspects of the present disclosure;

FIG. 2 is a block diagram, illustrating a system providing a network path between a client device and an endpoint where network issue causation detection is implemented, in accordance with aspects of the present disclosure;

FIG. 3 is a flowchart depicting a process for identifying a cause of a communication issue with respect to a communication session between a client device and an endpoint, in accordance with aspects of the present disclosure;

FIG. 4 is a flowchart depicting a process for using indicators of performance issues (IPI) data to determine an endpoint as a cause of a communication issue, in accordance with aspects of the present disclosure;

FIG. 5 is a flowchart depicting a process for using IPI data in conjunction with queue monitoring data to determine a network congestion cause of a communication issue, in accordance with aspects of the present disclosure; and

FIG. 6 is another flowchart depicting a process for using IPI data in conjunction with queue monitoring data to determine a network delay cause of a communication issue in accordance with aspects of the present disclosure, in accordance with aspects of the present disclosure.

### DETAILED DESCRIPTION

With an increase in the sophistication and breadth of network infrastructures, identifying and locating a cause of network communication issues has become difficult and resource intensive. Analyzing packet drops across various network components in a network may provide an indication that a particular network component in the network is experiencing overload. However, such analysis of packet drops may not provide a granular identification of a cause of a communication issue during a particular communication session between a client device and an endpoint, which may result in erroneously attributing the network communication issues to problems with incorrect network components and/or network locations.

For example, packet drops may not account for other causes of a communication issue. Indeed, packet drops may not provide sufficient information to determine if the communication issue is arising at the endpoint (e.g., a destination endpoint of network communication from a client device), with the network service provider (e.g., a WAN operator), or at another source. Thus, analyzing packet drops, in isolation, may provide an incomplete analysis of communication issues and in some cases may provide faulty identification of network communication issue causation.

Moreover, intermediate routing devices are often shared. Many packets associated with different communication sessions between various client devices and endpoints may be communicated over common intermediate routing devices at any one time. Accordingly, a particular intermediate routing device experiencing packet drops may not address network issues with respect to a specific communication session. Thus, when a particular client device is experiencing a communication issue, a packet drop analysis, by itself, may not be associated with the particular client's network session and, thus, may not be the cause of the particular client device's communication issue. Similarly, it may be difficult to determine whether other communication sessions are burdening certain intermediate routing devices (e.g., causing a switch to drop packets), and, therefore, leading to communication issues across the shared network. Resultingly, it may be difficult to diagnose an actual network component causing the particular client device's communication issue and determine corresponding mitigation actions, such as performing load balancing or initiating other mitigation techniques to resolve the communication issue that the client device is experiencing.

Further, as networks grow and facilitate the transmission of an increasing number of packets over an increasing number of switches, the resources used to analyze packet drops may become significant. One client may transmit a significant number (e.g., thousands and/or millions) of packets across a variety of intermediate routing devices to facilitate one communication session. Network monitoring at scale, especially considering the number of client devices that may simultaneously communicate over the network, may be a significant hardware resource and time resource utilization.

With the foregoing in mind, the present disclosure describes techniques for an efficient identification of the location (e.g., network component and/or a particular network (e.g., LAN or WAN)) causing a network communication issue between a client device and an endpoint. More specifically, the present disclosure describes a workflow for analyzing indicators of performance issues (IPI) data, such as Transmission Control Protocol (TCP) performance metric data, in conjunction with queue monitoring data to locate a component of the network path that is associated with the communication issue. That is, a particular component of the network path and/or particular network on the network path of a network communication may be identified as a cause of the network communication issue by aggregating and analyzing received IPI data and queue monitoring data from the intermediate routing devices that are part of the network path between the client device and the endpoint. For example, the workflows presented herein evaluate TCP IPI data obtained from an access network component, such as an access switch, used by the client device to access a local network of the network communication and queue monitoring data from a plurality of intermediate routing devices in the network path of the network communication to provide an efficient technique for identifying the location of the communication issue, which may lead to a more efficient troubleshooting and/or mitigation response when such communication issues arise.

In TCP communication, when a client device initiates a communication session with an endpoint, the client device may first communicatively connect to the endpoint across the network (herein referred to as a “TCP handshake”). TCP IPI data may be provided as a part of this TCP handshake and may be indicative of a performance of the communication between the client device and the end point. A Network Issue Causation Detection (NICD) system may receive and analyze the received TCP IPI data (e.g., patterns of the TCP performance metrics) to identify a likely category of communication issues. The likely category may indicate the location of the communication issue and/or provide an initial step in locating a network component that is likely the cause of the communication issue. For example, as will be described in detail below, the NICD system may use the IPI data to determine that the communication issue is associated with network congestion, network delay, and/or that the communication issue is arising at the endpoint of the network communication. In some situations, queue monitoring data may be used to further pinpoint the location of the communication issue. That is, the NICD system may also receive queue monitoring data from a plurality of intermediate routing devices (e.g., an access switch, aggregate switches, core switches, and wide area network (WAN) edge devices) in the network path between the client and the endpoint. After receiving and analyzing the IPI data, the NICD system may analyze the queue monitoring data at the intermediate routing devices in the network path to determine a location (e.g., a particular network (e.g., a LAN or WAN) and/or the network component) likely causing the communication issue. For example, the network component likely causing the communication issue may be a component of the network path, such as one or more intermediate routing devices, the endpoint, or the network service provider (e.g., that provides the remote network (e.g., WAN)).

After identifying the location (e.g., particular network and/or network component) that is likely the cause of the communication issue, the NICD system may generate an alert to a network entity (e.g., an electronic device and/or computing service communicatively coupled to the NICD system) associated with the identified location (e.g., at least one network entity assigned to monitor and/or operationally control the particular network and/or network component, such as: an application server associated with the endpoint; a network management service, or an internet service provider's monitoring and/or notification system) and/or another electronic device. The alert may indicate that the network component is believed to be a cause of the communication issue, the conditions that the network component is experiencing that lead to the communication issue, and/or possible mitigation actions to resolve the communication issue. The alert may be provided as a graphical user interface (GUI) alert, an electronic mail (e-mail), an electronic push notification, and/or other electronic communication.

In this manner, the NICD system may rapidly and accurately identify a location that is likely the cause of a network communication issue, even when the network is highly complex, having numerous intermediate components. An indication of this identified location may be automatically provided via an alert to a network entity associated with the identified location, resulting in efficient notification of the likely cause of the network communication issue

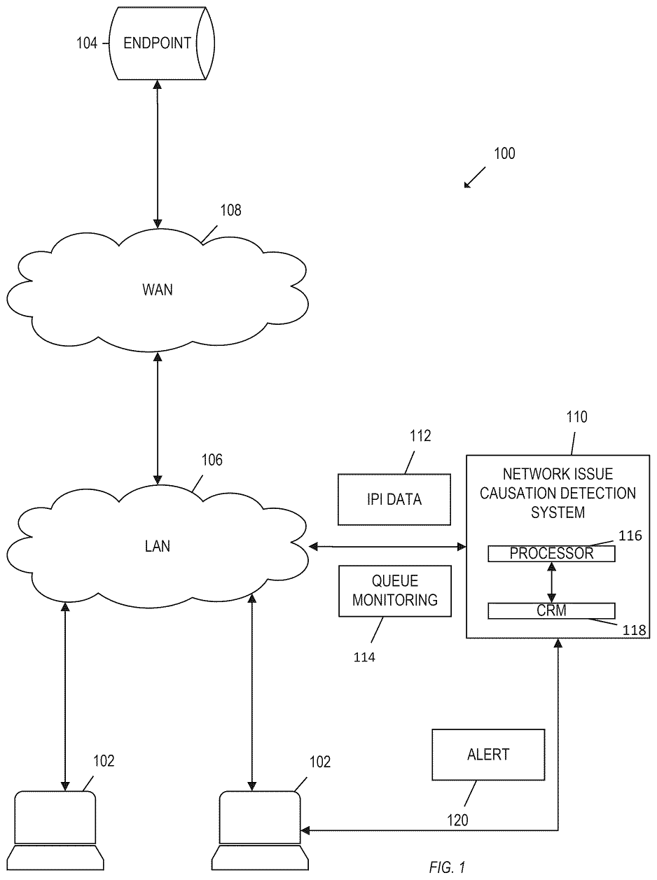

With the preceding discussion in mind, FIG. 1 is a block diagram, illustrating components of a network-based communications system 100 that performs a network issue causation analysis, in accordance with aspects of the present disclosure. The network-based communications system 100 may include various client devices 102 (e.g., electronic devices, such as personal computers (PCs), laptops, and/or servers, that initiate a network communication), an endpoint 104 (e.g., a destination endpoint/electronic device, such as a PC, laptop, and/or server that is the targeted destination of the network communication initiated by the client devices 102), a local network (e.g., local area network (LAN) 106) that is local to client devices 102, a remote network (e.g., wide area network (WAN) 108), and a Network Issue Causation Detection (NICD) system 110.

The client devices 102 may attempt to communicate with the endpoint 104 that is remote from the client device 102. For example, the client device 102 may attempt to communicate with the endpoint 104 that is located on the WAN 108 outside of the LAN 106 of the client device 102.

The endpoint 104 may be any electronic device that can interact with the client devices 102 by sending and receiving electronic data. For example, the endpoint 104 may be a server that hosts an application, such as a Voice over IP (VoIP) or video teleconferencing application. In other cases, the endpoint 104 may be a user-facing device (e.g., another mobile phone, laptop). The endpoint 104 may communicate with multiple client devices 102. Although the present depiction includes one endpoint 104, any number of endpoints 104 may be accessible by the client devices 102 across the LAN 106 and/or the WAN 108.

The client devices 102 may communicate with the endpoint 104 by transmitting packets to the endpoint 104 across the LAN 106 and the WAN 108. These packets may traverse many intermediate routing devices (e.g., switches and/or routers), which are used to direct the packets to the endpoint 104. That is, both the LAN 106 and the WAN 108 may be made up of many intermediate routing devices for facilitating the communication between the client device 102 and the endpoint 104. Multiple client devices 102 may be connected to the LAN 106 and, likewise, many client devices 102 may be communicating over the WAN 108. When a particular client device 102 is experiencing communication issues (e.g., sluggishness, crashes) it may be useful to locate the source of the communication issue. The location of the communication issue may be provided, for example, to the network service provider of the LAN 106 and/or the WAN 108 to troubleshoot the communication issue and restore communication to a desired operational level.

The NICD system 110 may be a computing device (e.g., having a processor 116), such as a server. In some cases, the NICD system 110 functionality may be implemented as an application and/or other computing-device implemented instructions (e.g., a server-based application, a cloud-based application) stored on a non-transitory computer-readable medium 118. The computer-implemented instructions, when executed by the processor 116 may implement the functionality of the NICD system 110 described herein. Initially, it should be noted that although the system 100 depicted in FIG. 1 illustrates the NICD system 110 as being communicatively connected to the LAN 106, the NICD system 110 can be implemented at any network level. For example, the NICD system 110 may be implemented at the WAN 108, a personal area network (PAN), a campus area network (CAN), a metropolitan area network (MAN), or any other suitable networking environment.

The NICD system 110 may facilitate this network communication issue causation analysis to identify the location causing the network communication issue. To perform the network communication issue causation analysis, the NICD system 110 may receive Indication of Performance Issue (IPI) data 112, which may be performance metric data indicative of a performance issue from the LAN 106. In some cases, such as in transmission control protocol (TCP) packets and/or precision time protocol (PTP) packets, the IPI data 112 may be extracted from these packet headers. In Transmission Control Protocol (TCP) communications, for example, TCP packet headers may include TCP IPI data 112. The NICD system 110 may use this IPI data 112 to determine a type of communication issue that is associated with the communication session between the client device 102 and the endpoint 104.

Continuing with the description of the network communication system 100, the NICD system 110 may continuously receive data, such as the IPI data 112 from the LAN 106. For example, the IPI data 112 may be received in TCP packet headers each time packets are exchanged between the client device 102 and endpoint 104 as a function of the TCP communication. In some cases, the NICD system 110 may request and/or receive the IPI data 112 in response to a reported communication issue associated with the client device.

The NICD system 110 may also receive intermediate routing device data periodically (e.g., at regular intervals). For example, the NICD system 110 may receive queue monitoring data 114 (e.g., queue status data indicative of packets being dropped or delayed at a port of an intermediate routing device) from the intermediate routing devices in the LAN 106 and/or the WAN 108 incrementally. That is, the NICD system 110 may receive data every second, every ten seconds, every minute, and/or at any other specified time range. In some cases, the NICD system 110 may request or retrieve data from the LAN 106. For example, if the NICD system 110 identifies that a communication issue is arising based on the IPI data 112, it may access the queue monitoring data 114 of a set of intermediate routing devices associated with a path of a communication session between the client device 102 and the endpoint 104 to further pinpoint a cause of the communication issue. That is, in some cases, the NICD system 110 may identify, based on the IPI data 112 in conjunction with the queue monitoring data 114, that a communication issue is arising with respect to a particular communication session between a client device 102 and an endpoint 104, or a set of client devices 102 and endpoints 104. Further, using the IPI data 112 in conjunction with the queue monitoring data 114, the NICD system 110 may identify a likely location (e.g. LAN 106 or WAN 108 and/or a particular component of LAN 106 or WAN 108) causing the communication issue of the particular communication session. Specifically, data patterns in the IPI data 112 and/or queue monitoring data 114 may be observed to identify the likely location, as described in detail below.

Upon identifying the communication issue and/or the location of the cause of the communication issue, the NICD system 110 may generate and provide an alert 120. For example, the alert may include a graphical user interface (GUI) dialog box, a push notification to a particular electronic device, such as the client device 102, endpoint 104, and/or a monitoring service of the system 100. The alert may include, in some cases, an indication of the network issue and an indication of the identified location of the network issue. In this manner, notification of the cause of the network issue may be quickly and effectively provided for rapid response.

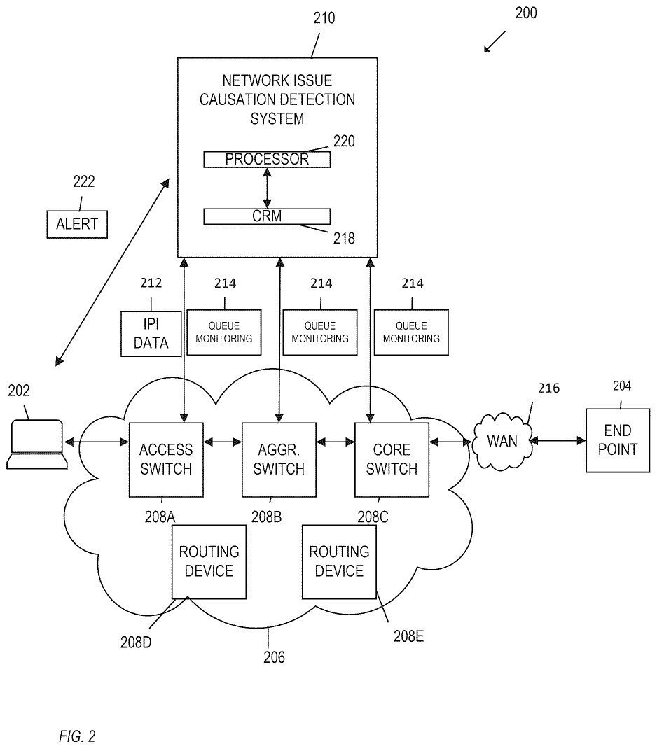

Turning now to a more detailed example, FIG. 2 is a block diagram, illustrating a system 200 with a detailed network path between a client device 202 (e.g., client device 102 of FIG. 1) and an endpoint 204 (e.g., endpoint 104 of FIG. 1). For instance, in the current example, the client device 202 communicates with the endpoint 204 across a LAN 206 (e.g., LAN 106 of FIG. 1). The LAN 206 may include various intermediate routing devices that form at least a portion of the network path (e.g., facilitate network communication) between the client device 202 and the endpoint 204. For example, the LAN 206 may include intermediate routing devices such as an access switch 208A, an aggregation switch 208B, and a core switch 208C on the network path between the client device 202 and the endpoint 204. In some cases, the LAN 206 may include additional and/or alternative types of intermediate routing devices on the network path, such as a WAN edge device. The LAN 206 may also include intermediate routing devices 208D, 208E that are not part of the network path between the client device 202 and the endpoint 204. When the client device 202 desires to communicate with the endpoint 204, it may transmit packets targeting the endpoint 204 (e.g., as indicated by destination information on the packets' headers) to the access switch 208A of the LAN 206. The access switch 208A may read a header from the packets and transmit the packets to the appropriate destination, such as aggregation switch 208B. Each packet may be transmitted across the LAN 206 until it reaches an intermediate routing device (e.g., the core switch 208C) on the edge of the LAN 206. The packet may then be transmitted through other networks, such as a WAN 216 (e.g., WAN 108 in FIG. 1), to reach the endpoint 204. After traversing the WAN 216, and potentially other networks, the packet may be received by the endpoint 204.

A communication session may include multidirectional communications. For example, the client device 202 may send packets to the endpoint 204 and the endpoint 204 may send packets to the client device 202. In some cases, these communications may occur on separate network paths. For example, dynamic routing and load balancing may affect the network path between the client device 202 and the endpoint 204. In this way, the network path may be different for packets that the client device 202 sends compared to packets that the client device 202 receives.

An NICD system 210 (e.g., NICD system 110 of FIG. 1) may include a non-transitory computer-readable medium (CRM) 218 (e.g., CRM 118 of FIG. 1) that stores computer-readable instructions that, when executed by processor(s) 220 (e.g., processor(s) 116 of FIG. 1) of the NICD system 210 cause the NICD system 210 to perform a network communication issue causation analysis. For example, the NICD system 210 may accumulate data from the intermediate routing devices in the LAN 206. For example, the NICD system 210 may receive TCP IPI data 212 (e.g., IPI data 112 of FIG. 1) from the access switch 208A. In some cases, the NICD system 210 may receive Transmission Control Protocol (TCP) IPI data 212 from the access switch 208A. TCP IPI data 212 may refer to various categories of data associated with a TCP-based communication session between the client device 202 and the endpoint 204 across the access switch 208A. TCP IPI data 212 may provide indicators of data flow in both directions (e.g., from the client device 202 to the endpoint 204 or from the endpoint 204 to the client device 202).

The NICD system 210 may also receive queue monitoring data 214 from the various intermediate routing devices in the network path. Each intermediate routing device may have out port queues (OPQs). For example, the access switch 208A may receive packets from the client device 202 and perform a forward lookup to determine the appropriate OPQ that the packet should go to. The access switch 208A may use a differentiated services code point (DSCP) value of the packet header to add the packet to the OPQ with the appropriate priority. A packet scheduler (not illustrated) may then dequeue the packets and cause the packets to egress from the OPQ (e.g., to be sent to another intermediate routing device (e.g., from access switch 208A to aggregation switch 208B). This process may be repeated by each intermediate routing device in the network path. That is, to organize packets that the intermediate routing devices receive, OPQs are used to determine the order of processing and transmitting the received packets to a target destination. Intermediate routing devices may have multiple OPQs that are associated with different communication sessions, different communication priorities, or the like. For example, an intermediate routing device may have a high priority OPQ for communication sessions that are deemed high priority.

The NICD system 210 may receive queue monitoring data 214 for queues associated with the network communication from the intermediate routing devices in the network path between the client 202 and the endpoint 204. In this system 200, for example, the NICD system may receive queue monitoring data 214 from the access switch 208A, the aggregation switch 208B, and the core switch 208C. The queue monitoring data 214 for the specific queues used by the network communication may be retrieved for communication issue causation analysis by the NICD system 210. Although this example depicts three intermediate routing devices in the network path, queue monitoring data 214 may also be taken from various other types of intermediate routing devices, such as additional switches, routers, WAN edge devices, and other devices in the network path. The NICD system 210 may analyze the queue monitoring data 214 in conjunction with the TCP IPI data 212 to locate a cause of the communication issue.

In response to identifying the location of the cause of the communication issue, the NICD system 210 may provide an alert 222 (e.g., alert 120 of FIG. 1) to one or more network entities. For example, here, the client device 202 that is experiencing the network communication issue is provided alert 202, which may indicate the location of the cause of the network communication issue.

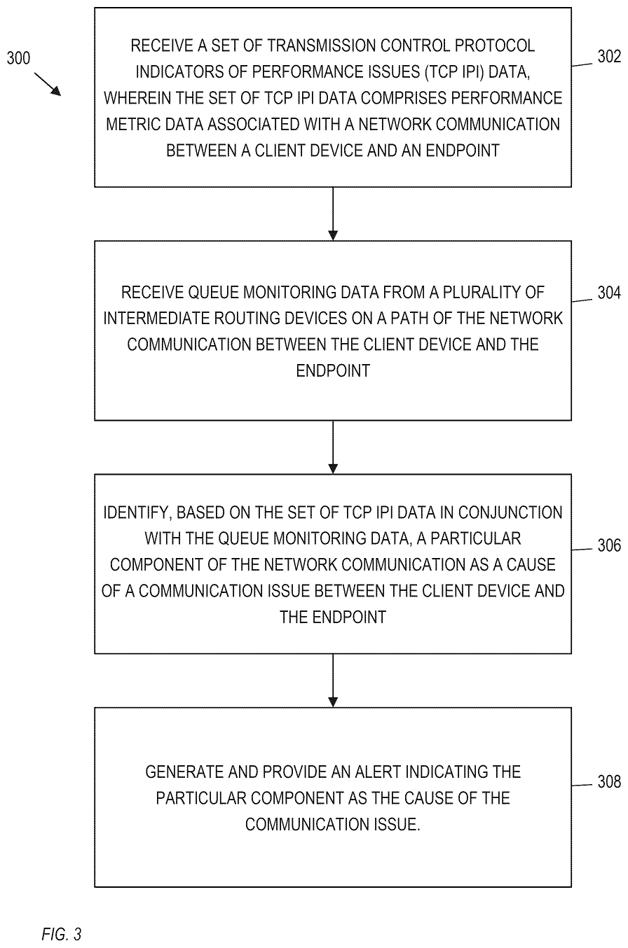

FIGS. 3-6 provide processes for identifying a location of a cause of a network issue using the IPI data in conjunction with the queue monitoring data. These processes may be implemented by the NICD system (e.g., NICD system 110 of FIG. 1 and/or NICD system 210 of FIG. 2). For example, the processes of FIGS. 3-6 may be implemented via the computer-implemented instructions stored by the computer-readable medium 118 of FIG. 1 and executed via the processor(s) 116 of FIG. 1 and/or computer-implemented instructions stored by the computer-readable medium 218 of FIG. 2 and executed via the processor(s) 220 of FIG. 2.

FIG. 3 provides a flowchart diagram of a process 300 for identifying and locating a location as a cause of network communication issues. Although the following description of the process 300 is described as being performed by the NICD system (e.g., NCID system 110 of FIG. 1, NICD system 210 of FIG. 2), it should be noted that any suitable device capable of receiving and processing data may perform the process 300 described herein. In addition, although the process 300 is described in a particular order, it should be understood that the process 300 may be performed in any suitable order and may exclude one or more of the blocks described herein.

As described in detail below, the NICD system may analyze TCP IPI data to determine conditions associated with the client device and the endpoint. Accordingly, at block 302, the NICD system receives a set of TCP IPI data (e.g., IPI data 112 of FIG. 1, TCP IPI data 212 of FIG. 2), which may include performance metric data about a network communication between a client device (e.g., client device 102 of FIG. 1, client device 202 of FIG. 2) and an endpoint (e.g., client device 102 of FIG. 1, endpoint 204 of FIG. 2). For example, the NICD system may receive TCP IPI data from the access switch (e.g., access switch 208A of FIG. 2) that the client device is communicating with. TCP IPI data may be received in the headers of TCP packets.

The TCP IPI data may provide different information at different stages of communication between the client device and the endpoint. For example, the NICD system may receive a first portion of the set of TCP IPI data during a connection setup/TCP handshake phase between the client device and the endpoint. The NICD system may also receive a second portion of the TCP IPI data, which may be indicative of a steady state communication phase between the client device and the endpoint. Different categories (e.g., performance metrics) of TCP IPI data will be summarized in the following paragraphs. However, it should be noted that additional categories of TCP IPI data may also be considered in the communication issue causation analysis presented herein and, therefore, fall within the spirit of this disclosure.

### Initial State IPI Data

One category of IPI data may be an initial round trip time (RTT) of the TCP handshake. The initial RTT is indicative of the time range for the client device to connect to the endpoint. The TCP handshake starts with the client device sending a synchronize (SYN) packet to the endpoint. The endpoint may respond with a synchronize acknowledgment packet (SYN ACK). Then the client device may respond with an acknowledgment packet (ACK), which completes the TCP handshake between the client device and the endpoint. The initial RTT may refer to an amount of time between sending the SYN packet to the endpoint and receiving the SYN ACK packet from the endpoint. The initial RTT may be determined, for example, according to Precision Time Protocol (PTP) packets or timestamps on TCP packets.

Another category of IPI data may be an initial receive window size (RWS). The RWS refers to the amount of data (e.g., the amount of bytes) that the client device and the endpoint can accept. That is, the client device and the endpoint may have buffers (e.g., temporary storage) that define the amount of data that each can process at a given time. For example, the client device may have an initial buffer size (e.g., megabytes, kilobytes) that is available to receive data. The endpoint may dynamically adjust the RWS communicated to the client device, based upon a dynamic amount of data that the endpoint is able to receive. Conversely, the client device may dynamically adjust the RWS communicated to the endpoint. In some cases, the intermediate routing devices along the network path (e.g., the access switch 208A, the aggregation switch 208B, the core switch 208C of FIG. 2) of the network communication may also dynamically adjust the RWS to either client device and/or endpoint depending on the packet flow direction.

Another category of initial IPI data may be a maximum segment size (MSS). TCP packets may be made up of headers (e.g., an internet protocol (IP) header and a TCP header) and a segment. The segment may may be the unit of data that is carried by the TCP packet. The MSS is the size of the segment that the endpoint can send to the client device and that the client device can send to the endpoint. In some situations, intermediate routing devices in the network path may have varying MSS parameters. If the segment size of a packet surpasses the MSS parameter of a particular intermediate routing device, the packet may be dropped or fragmented. Therefore, during the TCP handshake, the endpoint may adjust or clamp the MSS that the client device can send to it. For example, if the three intermediate routing devices have an MSS parameter of 1460 bytes and a fourth intermediate routing device has an MSS parameter of 1220 bytes, the endpoint may set the MSS at 1220 to prevent packet dropping or fragmentation.

An initial category of IPI data may also be related to an OPQ cache. As described above, during the TCP handshake when the access switch receives packets from the client device, it may perform a forward lookup to determine the appropriate OPQ on the access switch that the packet is processed by. This process may be repeated for each intermediate routing device in the network path. The OPQ cache data refers to an identity of a designated OPQ for the network communication.

### Steady State IPI Data

The NICD system may also receive and analyze IPI data throughout the course of the communication session between the client device and the endpoint. An example of a steady state IPI data category may be an ongoing RTT. As described with respect to initial RTT, the client device and the endpoint communicate with acknowledgments. That is, whenever a packet is received, the receiver should send an acknowledgment to the sender. Ongoing RTT refers to the times range between a sender sending a packet and the sender receiving an acknowledgment of that packet. In this way, ongoing RTT may provide a continuous tracking of RTT during the steady state communication.

Another category of steady state IPI data may be an ongoing RWS. Similar to the initial RWS, ongoing RWS refers to the maximum buffer that the client device or the endpoint can accept at any given time. During the course of the communication session, the buffers on the client device or endpoint may change. For example, if the client device initiates multiple applications after the TCP handshake, its buffers may decrease. Thus, the client device may dynamically adjust the ongoing RWS. The endpoint may, therefore, decrease the number of packets that it can send to the client device before the endpoint receives acknowledgments.

An additional category of steady state IPI data may be an indication of TCP retransmission (TCP Re-xmit). As described above, TCP protocol specifies that when a packet is sent, it should be acknowledged. The acknowledgment may be based on a sequence number of the packet that is sent. The sequence number may be stored in the packet header to indicate the first byte of data in the packet. For example, the client device may acknowledge that it has received a packet from the endpoint by sending an ACK packet that corresponds to the sequence number of the received packet. If the sender does not receive an acknowledgment, it may retransmit the original packet with the same sequence number. That is, TCP Re-xmit may indicate that one or more intermediate routing had a full OPQ causing it to drop packets, and that the sender is now performing a slow start (e.g., retransmitting TCP segments of the dropped packets according to packet sequence numbers that were not acknowledged). TCP Re-xmit may refer to the total number of packets that are retransmitted during a communication session, a percentage of the number of packets being retransmitted (e.g., one percent of all packets sent during the communications session are retransmitted), or the rate at which packets are retransmitted during the communication session (e.g., ten packets are retransmitted in a five second interval).

The steady state IPI data may also include a TCP congestion window reduced (CWR) flag. The CWR flag is an indication provided to the client device specifying that the client device should reduce its transmission rate. The CWR flag may be in response to an explicit congestion notification echo (ECE) bit being included in the TCP header of one or more packets. The ECE bit may be generated by an intermediate routing device on the network path, such as the access switch, to indicate that the intermediate routing devices are experiencing network congestion. This may occur, for example, when an OPQ on the network path between the client device to the endpoint is at full capacity or approaching full capacity. The CWR flag differs from the other categories of steady state IPI data (e.g., ongoing RTT and ongoing RWS) because it is associated with the intermediate routing device experiencing congestion, rather than the endpoint.

Returning now to a description of the process 300 of identifying and location network communication issues, at block 304, the NICD system may receive queue monitoring data (e.g., queue monitoring data 114 of FIG. 1, queue monitoring data 214 of FIG. 2) from a plurality of intermediate routing devices on a path of the network communication between the client device and the endpoint. That is, the NICD system may receive queue monitoring data pertaining to the specific OPQs that the client device and the endpoint are communicating across. In some cases, the NICD system may periodically receive the queue monitoring data. In other cases, the NICD system may request the queue monitoring data from a subset of intermediate routing devices based on an analysis of the IPI data (e.g., when an analysis of the IPI data indicates a network communication issue).

One example of queue monitoring data may include queue packet drops (Q-Drop). Q-Drops may refer to the total number of packet drops or the rate at which packets are dropped within respective OPQs at the intermediate routing devices during a given time period. Q-Drops may also be analyzed at different levels of granularity. That is, the NICD system may receive Q-Drop data for the particular OPQs that the client device and the endpoint use.

Another example of queue monitoring data may include queue utilization (Q-Util). Each intermediate routing device may monitor and report a percentage of its OPQ utilization for a set time range. Q-Util refers to the percentages of the OPQs of the intermediate routing devices that are occupied during that interval. For example, an OPQ may be able to hold 100 packets at a given time. If the OPQ holds an average of 50 packets during a defined interval (e.g., five seconds), then the Q-Util is 50 percent.

A further example of queue monitoring data may refer to queue delay (Q-Delay). Q-Delay may refer to delay and variance from ingress to egress in an OPQ. When packets arrive at the intermediate routing devices, they may be separated into OPQs. There may be a delay (e.g., in milliseconds, microseconds) in the amount of time packets spend in the OPQ. Q-Delay may refer to a high (e.g., above a defined threshold) average amount of time each packet spends in the OPQ (e.g., packets spend an average of one second in a particular OPQ). Q-Delay may also refer to queue jitter. Queue jitter is a measure of variance or fluctuation in the amount of time that packets spend in the OPQ. That is, one packet may spend a millisecond in an OPQ, and a second packet may spend 500 milliseconds in the same OPQ. Q-Delay may be determined according to timestamped Precision Time Protocol (PTP) packets. An intermediate routing device may, for example, periodically transmit a loopback PTP packet into its own OPQ. The PTP packet is timestamped as it reaches the top of the queue (e.g., to be egressed). Rather than transmitting the PTP packet to another intermediate routing device, it is looped back to be processed by the same intermediate routing device that it was enqueued in. The PTP packet may be used to calculate a queue time (e.g., the amount of time the PTP packet spent in the queue is calculated according to its timestamp) to determine if there is delay and/or if there have been fluctuations compared to previous measurements. Practically, Q-Delay may impact streaming or vocal communications. For example, Q-Delay may be associated with a lag in output during a teleconference causing one presenter's voice to rapidly speed up.

At block 304, the NICD system identifies, based on the set of TCP IPI data 212 in conjunction with the queue monitoring data, a particular component of the network communication as a cause of a communication issue between the client device and the endpoint. The particular component of the network may be, for example, one or more of the intermediate routing devices on the network path. The particular component may also be the endpoint, such as a communication issue arising on an application server. Alternatively, the particular component may be a service provider, such as an internet service provider associated with a WAN in the path between the client device and the endpoint.

Trends or patterns in the IPI data and queue monitoring data may be indicative of the particular component that is a cause of the communication issue. The NICD system may perform this analysis automatically, such as in cases where it automatically receives IPI data and queue monitoring data. In other cases, the NICD system may analyze the IPI data and queue monitoring data when it is notified that a communication issue is occurring (e.g., by the client device or a system administrator).

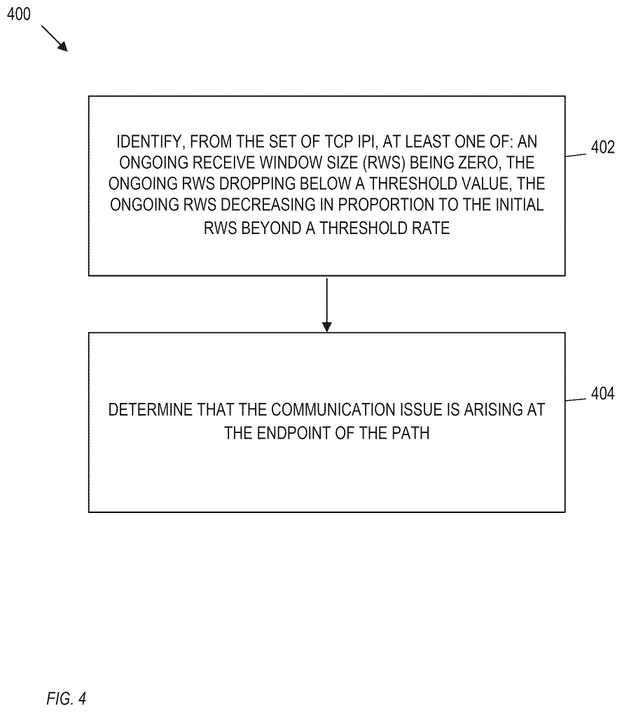

Turning to the specific patterns in the IPI data and queue monitoring data that indicate particular locations of causes of network communication issues, FIGS. 4-6 provide examples of using the IPI data to determine the particular component that is a cause of the communication issue. Although these examples refer to specific categories of IPI data, queue monitoring data, and calculations, additional parameters and calculations that use IPI data alone or in combination with queue monitoring data may also be indicative of a communication issue. While each of the processes of FIGS. 4-6 are illustrated as separate processes, all or a subset of the processes may, in some cases, be used in conjunction with one another to identify different locations where different network communication issues arise.

FIG. 4, for example, provides a flowchart depicting a process 400 of using indicators of performance issues (IPI) data to determine that the communication issue is arising at an endpoint of the communication session. At block 402, the NICD system identifies, from the set of TCP IPI, at least one of: an ongoing RWS being zero, the ongoing RWS dropping below a threshold value, or the ongoing RWS decreasing in proportion to the initial RWS beyond a threshold rate. The NICD system may identify that the ongoing RWS is zero when the endpoint is not accepting any packet transmissions. This may occur, for example, when the buffers of the endpoint are full or overloaded. The NICD system may identify that the ongoing RWS drops below a threshold value, which may be a predetermined minimum amount of available storage on the endpoint buffers. For example, the NICD system may identify that the ongoing RWS at the endpoint is 1 kilobyte, when the threshold ongoing RWS is set to 5 kilobytes. Further, the NICD system may identify that the ongoing RWS may be decreasing in proportion to the initial RWS beyond a threshold rate (e.g., 10%, 20%). This may happen when the available storage at the endpoint buffers decreases over the course of the communication session between the client device and the endpoint.

At block 404, in response to one of the conditions being identified in block 402, the NICD system determines that the communication issue is arising at the endpoint of the path. That is, in response to identifying that the ongoing RWS is zero, the ongoing RWS has dropped below a threshold value, and/or the ongoing RWS is decreasing in proportion to the initial RWS beyond a threshold rate, the NICD system determines that the endpoint is the particular component of the network communication that is a cause of the communication issue between the client device and the endpoint. In some cases, the NICD system may make this determination without analyzing any queue monitoring data. Indeed, at block 402 the NICD system identified that the endpoint buffers (as determined by the ongoing RWS) were experiencing conditions that led to them being full or at least decreasing. If the endpoint is an application server, for example, this may be indicative of an issue occurring at the server, which may indicate that the intermediate routing devices and other components of the network path are not the cause of the communication issue.

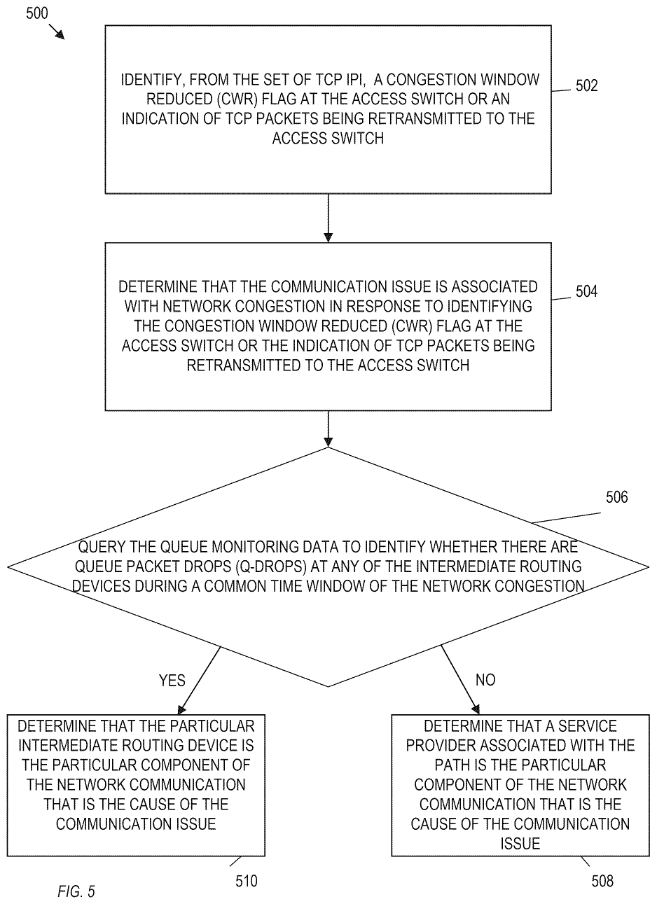

As mentioned above, the NICD system may also use the queue monitoring data to determine the particular component of the network communication that is a cause of a network congestion communication issue. FIG. 5 provides an example flowchart depicting a process 500 of using IPI data in conjunction with queue monitoring data. At block 502, the NICD system identifies, from the set of TCP IPI data, a CWR flag at the access switch or an indication of TCP Re-xmit. The CWR flag, as described above, may arise when there is network congestion at one or more intermediate routing devices in the path between the client device and the endpoint. The CWR flag is an indication to the client device to slow its transmission rate to reduce load on the OPQ of at least one of the intermediate routing devices. At this block, the NICD system may also identify that the total number of packets being retransmitted or the rate at which packets are transmitted surpasses a certain threshold. That is, the NICD system may identify that TCP Re-xmit is surpassing a threshold.

At block 504, in response to identifying one of the conditions of block 502, the NICD System determines that the communication issue is associated with network congestion. For example, as mentioned above, the CWR flag may indicate that the client device should reduce its transmission rate. This request may indicate that the network is unable to handle the previous transmission rate of the client device and, thus, that there is network congestion. Further, packet retransmission may be triggered based upon dropped packets, indicating that the network is unable to handle all of the packets provided by the client device and, thus, that there is network congestion.

Turning to decision block 506, the NICD system queries the queue monitoring data to identify whether there are Q-Drops at any of the intermediate routing devices on the network path between the client device and the endpoint during a common time window (e.g., pre-defined surrounding range of time) of the network congestion. The NICD system may receive queue monitoring data from the intermediate routing devices in the network path between the client device and the endpoint. After the IPI data indicates that there is a network congestion issue, the NICD system may query the monitoring data to determine if there are any Q-Drops and/or Q-Util exceeding a pre-defined threshold on the relevant OPQs of the intermediate routing devices on the network path between the client device and the endpoint. In some cases, the NICD system may analyze the queue monitoring data for a threshold amount of Q-Drops and/or a breach of a Q-Util threshold at each OPQ that was used for the network communication (e.g., the communication session) during a relevant common time window of the network congestion.

For efficient and effective analysis, the NICD system may analyze a subset of the queue monitoring data that occurs at a threshold time around identified network congestion (e.g., the common time window). For example, if the NICD system periodically receives the queue monitoring data, it may analyze the queue monitoring data that is received within two cycles before and two cycles after the NICD system identified network congestion. Alternatively, the NICD system may query the queue monitoring data for a threshold amount of time (e.g., one minute) before and/or after a time of identified network congestion.

If there are no Q-Drops at any of the intermediate routing devices during a common time window of network congestion, the process 500 continues at block 508, where the NICD system determines that the particular component causing the communication issue is arising outside of the LAN (e.g., at a service provider of the network). For example, the particular component causing the communication issue may be identified as an internet service provider of a WAN that the packets are transmitted across.

Conversely, if there are Q-Drops at a particular intermediate routing device during a common time window of network congestion, the process 500 proceeds to block 510. At block 510 the NICD system determines that the intermediate routing device experiencing Q-Drops is the particular component of the network communication that is the cause of the communication issue. In some cases, multiple intermediate routing devices may be experiencing Q-Drops within the time period of the network congestion. In that case, the NICD system may determine that the multiple intermediate routing devices experiencing Q-Drops are the particular components of the network communication that are the causes of the communication issue.

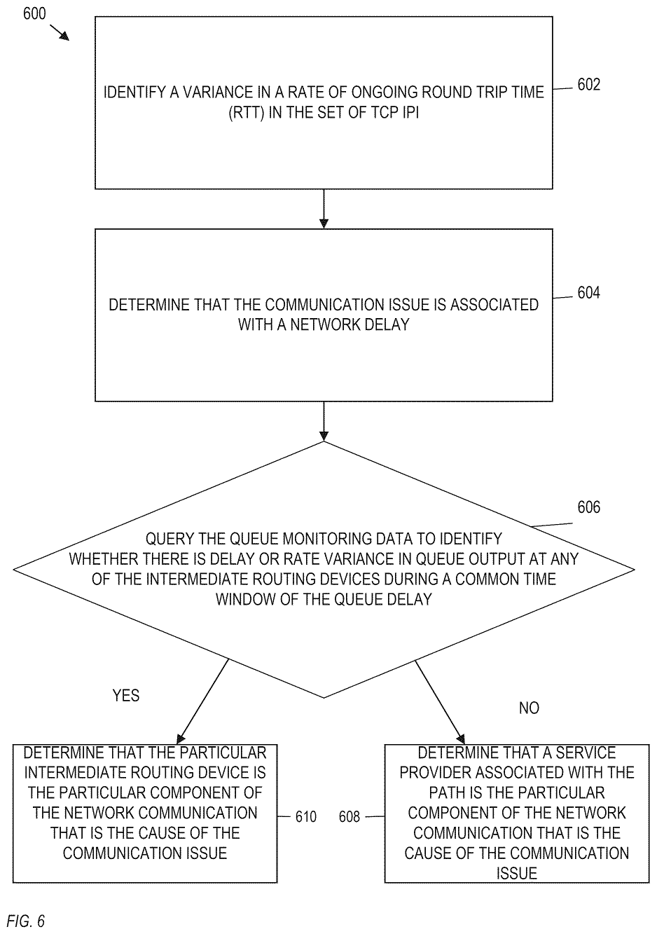

As mentioned above, the process 500 described with respect to FIG. 5 is one analytical workflow for determining which particular component of the network communication is the cause of a communication issue. FIG. 6 provides another example flowchart depicting a process 600 of using IPI data in conjunction with queue monitoring data to determine the location of a network delay communication issue.

At block 602, the NICD system identifies a variance in a rate of ongoing RTT in the set of TCP IPI. As described above, ongoing RTT is the amount of time that elapses after a sender (e.g., either the client device or the endpoint) transmits a packet to the time it takes the sender to receive an acknowledgment. The NICD system may identify when the ongoing RTT varies beyond a certain threshold (e.g., seconds, milliseconds). This rate variance may be indicative of faster communications (e.g., a lower ongoing RTT) or slower communications (e.g., a higher RTT).

Turning to block 604, in response to identifying the condition of block 602, the NICD system determines that the communication issue is associated with a network delay. That is, the rate variance in going RTT may be associated with network delay that is caused by an intermediate routing device in the path between the client device and the endpoint.

At decision block 606, the NICD system queries the queue monitoring data to identify whether there is Q-Delay (e.g., undesirable enqueuing periods from ingress to egress in an OPQ for packets of the network communication) and/or rate variance (e.g., rate changes in the enqueuing period over time that exceed a pre-defined threshold), in OPQs at any of the intermediate routing devices during a common time window of the network delay. As described with respect to decision block 506, the NICD system may check the queue monitoring data occurring at a threshold time before and/or after a time of the identified network delay. Using this queue monitoring data, the NICD system may determine if there is Q-Delay at any of the relevant OPQs of the intermediate routing devices between the client device and the endpoint in a common time window as the network delay. For example, if one OPQ is experiencing slow output beyond a certain threshold (e.g., 250 milliseconds) or if one OPQ is experiencing jitter, such as fluctuating OPQ processing periods (e.g., packet time in queue ranges between 1000 milliseconds to 400 milliseconds), then the NICD system may determine that the OPQ is experiencing Q-Delay.

If there is no Q-Delay or rate variance in queue output at an intermediate routing device during a common time window of network delay, the process 600 proceeds to block 608. At block 608 the NICD system determines that that a service provider associated with the network path is the particular component of the network communication that is the cause of the communication issue.

If there is Q-Delay and/or rate variance at an intermediate routing device during a common time window of the identified network delay, the process 600 proceeds to block 610. At block 610 the NICD system determines that the intermediate routing experiencing Q-Delay or rate variance is the particular component of the network communication that is the cause of the communication issue. Similarly, to block 510 described above, in some cases, multiple intermediate routing devices may be experiencing Q-Delay within a common time period of the network delay. In that case, the NICD system may determine that the multiple intermediate routing devices experiencing Q-Delay are particular components of the network communication that are the causes of the communication issue.

Referring back to FIG. 3 and moving now to block 306, the NICD system may generate and provide an alert indicating the particular component that has been identified as the cause of the communication issue. The alert may be sent to a variety of entities. For example, if the particular component of the network communication that is causing the communication issue is the endpoint, then the client device and the endpoint may be notified. Thus, if the endpoint is an application server, then the entity running the application or hosting the application servers may be notified. If the particular component causing the communication issue is an intermediate routing device, then a local system administrator or network management service may be notified. Further, if the particular component causing the communication issue is a service provider of a WAN, then that service provider may be notified.

The notifications may indicate how the communication issue was identified, possible causes of the communication issue, suggested mitigations for the communication issue, or the like. These examples illustrate that a benefit of the techniques described herein is that an entity that is associated with a communication issue that is impacting a communication session may be notified of the communication issue. This may promote faster network troubleshooting and communication issue resolutions by enabling responsible entity to resolve any conditions causing the communication issue before it spreads or becomes more severe (e.g., leading to total communication failures). Moreover, it may provide the other entities that are associated with the network communication session with an affirmative indication that their network components are innocent and are not experiencing any conditions that are negatively impacting clients.

As may be appreciated, the current techniques provide significant value. Specifically, the current techniques provide a network issue causation detection system that identifies the likely location causing a network communication issue between a client device and an endpoint. Further, the current techniques may identify rapidly and accurately identify the location that is likely the cause of a network communication issue, even when the network is highly complex, having numerous intermediate components.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A non-transitory, computer-readable medium, comprising computer-readable instructions that, when executed by one or more processors of one or more computers, cause the one or more computers to:
receive a set of transmission control protocol indicators of performance issues (TCP IPI) data, wherein the set of TCP IPI data comprises performance metric data associated with a network communication between a client device and an endpoint;
receive queue monitoring data from a plurality of intermediate routing devices on a path of the network communication between the client device and the endpoint;
identify, based on the set of TCP IPI data in conjunction with the queue monitoring data, a particular component on the path of the network communication as a cause of a communication issue between the client device and the endpoint; and
generate and provide an alert indicating the particular component as the cause of the communication issue.

2. The non-transitory, computer-readable medium of claim 1 comprising computer-readable instructions that, when executed by the one or more processors of the one or more computers, cause the one or more computers to:
select the particular component from a set of network components of the network communication, wherein the set of network components comprises:
the plurality of intermediate routing devices on the path,
the endpoint of the path, and
a service provider associated with the path.

3. The non-transitory, computer-readable medium of claim 1 wherein the performance metric data comprises at least one of:
a round trip time (RTT) indicated by one or more TCP packets;
a receive window size (RWS) of the one or more TCP packets,
out port queue cache data of an access switch of the path;
an indication of TCP packets being retransmitted;
a maximum segment size (MSS) indicated by the one or more TCP packets; or
a congestion window reduced (CWR) flag indicated by the one or more TCP packets.

4. The non-transitory, computer-readable medium of claim 3, comprising computer-readable instructions that, when executed by the one or more processors of the one or more computers, cause the one or more computers to:
receive a first portion of the set of TCP IPI data during a connection setup phase between a client and the endpoint, wherein the first portion of the set of TCP IPI data comprises at least one of:
an initial RTT, as indicated by an initial set of the one or more TCP packets communicated during the connection setup phase,
an initial RWS, as indicated by the initial set of the one or more TCP packets,
the out port queue cache data, or
the MSS, as indicated by the initial set of the one or more TCP packets; and
receive a second portion of the set of TCP IPI data during a steady state communication phase between the client and the endpoint, wherein the second portion of the set of TCP IPI data comprises at least one of:
an ongoing RTT, as indicated by a second set of the one or more TCP packets communicated during the steady state communication phase,
an ongoing RWS, as indicated by the second set of the one or more TCP packets,
the indication of TCP packets being retransmitted to the access switch, or the CWR flag, as indicated by the second set of the one or more TCP packets.

5. The non-transitory, computer-readable medium of claim 4, comprising computer-readable instructions that, when executed by the one or more processors of the one or more computers, cause the one or more computers to:
identify, from the set of TCP IPI, one or more conditions comprising at least one of:
the ongoing RWS being zero,
the ongoing RWS dropping below a threshold value, or
the ongoing RWS decreasing in proportion to the initial RWS beyond a threshold rate; and
in response to identifying the one or more conditions, determine that the endpoint of the path is the particular component of the network communication that is the cause of the communication issue.

6. The non-transitory, computer-readable medium of claim 4, comprising computer-readable instructions that, when executed by the one or more processors of the one or more computers, cause the one or more computers to:
identify, from the set of TCP IPI, one or more conditions comprising at least one of: the set of TCP IPI data comprising the CWR flag or the indication of TCP packets being retransmitted to the access switch; and
in response to identifying the one or more conditions, determine that the communication issue is associated with network congestion.

7. The non-transitory, computer-readable medium of claim 6, comprising computer-readable instructions that, when executed by the one or more processors of the one or more computers, cause the one or more computers to:
in response to identifying that the communication issue is associated with the network congestion:
query the queue monitoring data to identify whether there are queue packet drops (Q-Drops) in any queues associated with the out port queue cache data at any of the plurality of intermediate routing devices during a common time window of the network congestion;
when there are Q-Drops at a particular intermediate routing device of the plurality of intermediate routing devices, determine that the particular intermediate routing device is the particular component of the network communication that is the cause of the communication issue; and
when there are not Q-Drops at any of the plurality of intermediate routing devices, determine that a service provider associated with the path is the particular component of the network communication that is the cause of the communication issue.

8. The non-transitory, computer-readable medium of claim 4, comprising computer-readable instructions that, when executed by the one or more processors of the one or more computers, cause the one or more computers to:
identify that the TCP IPI data comprises a variance in a rate of the ongoing RTT; and
in response to identifying that the TCP IPI data comprises the variance in the rate of ongoing RTT, determine that the communication issue is associated with a network delay.

9. The non-transitory, computer-readable medium of claim 8, comprising computer-readable instructions that, when executed by the one or more processors of the one or more computers, cause the one or more computers to:
in response to determining that the communication issue is associated with the network delay:
query the queue monitoring data to identify whether there is at least one of: delay or rate variance in queue output at any of the plurality of intermediate routing devices during a common time window of the network delay;
when there is at least one of: delay or rate variance in queue output at a particular intermediate routing device of the plurality of intermediate routing devices, determine that the particular intermediate routing device is the particular component of the network communication that is the cause of the communication issue; and
when there is not at least one of: delay or rate variance in queue output at any of the plurality of intermediate routing devices, determine that a service provider associated with the path is the particular component of the network communication that is the cause of the communication issue.

10. The non-transitory, computer-readable medium of claim 1, wherein the TCP IPI data is extracted from at least one of: transmission control protocol (TCP) packets or precision time protocol (PTP) packets.

11. A processor-implemented method, comprising:
receiving a set of transmission control protocol indicators of performance issues (TCP IPI) data, wherein the set of TCP IPI data comprises performance metric data associated with a network communication between a client device and an endpoint;
receiving queue monitoring data from a plurality of intermediate routing devices on a path of the network communication between the client device and the endpoint;
identifying, based on the set of TCP IPI data in conjunction with the queue monitoring data, a particular component on the path of the network communication as a cause of a communication issue between the client device and the endpoint; and
generating and providing an alert indicating the particular components as the cause of the communication issue.

12. The processor-implemented method of claim 11, comprising:
identifying the particular component from a set of network components of the network communication, wherein the set of network components comprises:
a particular intermediate routing devices of the plurality of intermediate routing devices on the path,
the endpoint of the path, and
a service provider associated with the path.

13. The processor-implemented method of claim 12, comprising:
in response to identifying that the particular intermediate routing devices is the particular component, determining that an out port queue (OPQ) of a plurality of OPQs on the particular intermediate routing device as the cause of the communication issue.

14. The processor-implemented method of claim 12, wherein the particular component comprises at least two intermediate routing devices of the plurality of intermediate routing devices.

15. The processor-implemented method of claim 11, wherein the alert is provided to at least one networking entity with operational control of the particular component, comprising at least one of:
an application server associated with the endpoint;
a network management service, or
an internet service provider.

16. The processor-implemented method of claim 11, comprising:
determining, from the set of TCP IPI data, that the cause of the communication issue is associated with at least one of: network congestion or network delay.

17. The processor-implemented method of claim 16, wherein the alert includes an indication that the cause of the communication issue is associated with the at least one of: the network congestion or the network delay.

18. A Network Issue Causation Detection (NICD) system comprising:
a processor; and
a non-transitory, computer-readable medium comprising computer-readable instructions that, when executed by the processor, cause the processor to:
receive a set of transmission control protocol indicators of performance issues (TCP IPI) data, wherein the set of TCP IPI data comprises performance metric data associated with a network communication between a client device and an endpoint;
receive queue monitoring data from a plurality of intermediate routing devices on a network path of the network communication;
identify, based on the set of TCP IPI data in conjunction with the queue monitoring data, a particular component on the network path of the network communication as a cause of a communication issue between the client device and the endpoint; and
generate and provide an alert indicating the particular component as the cause of the communication issue.

19. The system of claim 18, wherein the NICD system is configured to:
receive a notification of the communication issue from the client device; and
in response to receiving the notification of the communication issue from the client device, request the queue monitoring data from the plurality of intermediate routing devices.

20. The system of claim 18, wherein the NICD system is configured to:
extract the set of TCP IPI data from TCP packets that are transmitted across at least part of the network path between the client device and the endpoint.
